(19) United States
(12) Patent Application Publication
(10) Pub. No.: US 2016/0147883 A1
(43) Pub. Date: May 26, 2016

(54) METHOD AND SYSTEM FOR DETERMINING DEFECTS PER UNIT OF A PRODUCT

(71) Applicant: Caterpillar Inc., Peoria, IL (US)

(72) Inventors: VIJAYSAI MUKUNDAN, Chennai (IN); Lakshya Saini, Chennai (IN)

(73) Assignee: Carterpillar Inc., Peoria, IL (US)

(21) Appl. No.: 14/982,123

(22) Filed: Dec. 29, 2015

(51) Int. Cl. G06F 17/30; G01M 99/00

(52) U.S. Cl. CPC G06F 17/30864; G01M 99/00

(57) ABSTRACT

A method, implemented on a computing device, for determining defects per unit of a product is disclosed. The method initiates with generating a data retrieval session between a processor and a database server. Thereafter, a product test data from the database server is retrieved based on a query executed by the processor. A data updating session between the database server and a plurality of data sources is then generated. The data updating session is terminated during retrieval of the product test data. Additionally, the product test data retrieved is inaccessible by the plurality of data sources. Moreover, the defects per unit is displayed through a display unit. The database server reactivates the data updating session with the data sources in response to the conclusion of the display of the defects per unit.

### TECHNICAL FIELD

The present disclosure relates generally to a method of determining defects per unit of a product. More specifically, the present disclosure relates to retrieval of product test data simultaneously from various data sources for determination of defects per unit of the product at an instance.

### BACKGROUND

Every manufactured product is subject to different types or modes of failures. Potential failures may have costly consequences and thereby effecting overall production cycle. Hence, it is required to effectively and efficiently, monitor the production cycle of the product and its manufacturing process, in order to identify the potential failures and associated risks at an early stage and thus achieve a better quality product.

Generally, defects per unit of the product is determined in order to identify cause and effect of the potential failures in the manufacturing process and/or in the design of the product, prioritize action plans to reduce the potential failures, track and evaluate results of the action plans, and eventually minimize or eliminate the potential failure and the associated risk. Defects per unit of the product is typically determined by a combination of a failure mode and effect analysis (FMEA) of the product, field issues analysis of the product, lab issues analysis of the product, and inherent issues analysis on previous machines. More specifically, defects per unit of the product is determined by performing certain calculations on a product test data retrieved from one or more of the above-mentioned analysis.

Furthermore, conventional methods of determining defects per unit of the product includes fetching the product test data from a centralized database server, performing calculations on the retrieved product test data, and determining defects per unit of the product. Notably, the product test data in the centralized database server is continuously updated by a plurality of data sources. Therefore, the product test data obtained during retrieval of the product test data may be inaccurate, as the product test data might had been updated in the database server after the retrieval operation has been performed. This may cause an incorrect determination of the defects per unit of the product.

Japanese Patent 04537491 discloses a centralized database connected to various distributed databases, to store overall entire data and manage it efficiently. Although this reference discusses a method of retrieving biological information by tracking link between a data retrieval source and distributed databases, however the centralized data in this reference may still be subject to updating during retrieval of biological information. This may still cause inaccurate retrieval of the biological information.

### SUMMARY OF THE INVENTION

Various aspects of the present disclosure are directed towards a method, implemented on a computing device, for determining defects per unit of a product. The computing device includes a processor and a display unit. The method initiates with generating a data updating session between a plurality of data sources and a database server. Thereafter, a data retrieval session between the database server and the processor is generated. A product test data from the database server is then retrieved based on a query executed by the processor. Notably, the data updating session between the database server and the plurality of data sources is terminated during retrieval of the product test data. The product test data is inaccessible by the plurality of data sources. A measure of defects per unit is then determined based on the product test data retrieved from the database server. The defects per unit is displayed through the display unit. The database server reactivates the data updating session with the plurality of data sources in response to the conclusion of the display of the defects per unit.

### BRIEF DESCRIPTION OF THE DRAWINGS

FIG. 1 is a block diagram of an exemplary environment that illustrates a database server and a user computing device, to determine defects per unit of a product, in accordance with the concepts of the present disclosure;

FIG. 2 is a block diagram of the user computing device of FIG. 1, in accordance with the concepts of the present disclosure;

FIG. 3 is a block diagram of the database server of FIG. 1, in accordance with the concepts of the present disclosure;

FIG. 4 is a flow chart of a method executed by the user computing device of FIG. 1, to determine the defects per unit of the product, in accordance with the concepts of the present disclosure;

FIG. 5 is a flow chart of a method executed by the database server of FIG. 1, to determine the defects per unit of the product, in accordance with the concepts of the present disclosure;

FIG. 6 is a message flow diagram of the method of determining the defects per unit of the product, in accordance with the concepts of the present disclosure; and

FIG. 7 is a screenshot of an exemplary interface of the user computing device of FIG. 1 for selecting a type of product for which the defects per unit is determined, in accordance with the concepts of the present disclosure.

### DETAILED DESCRIPTION

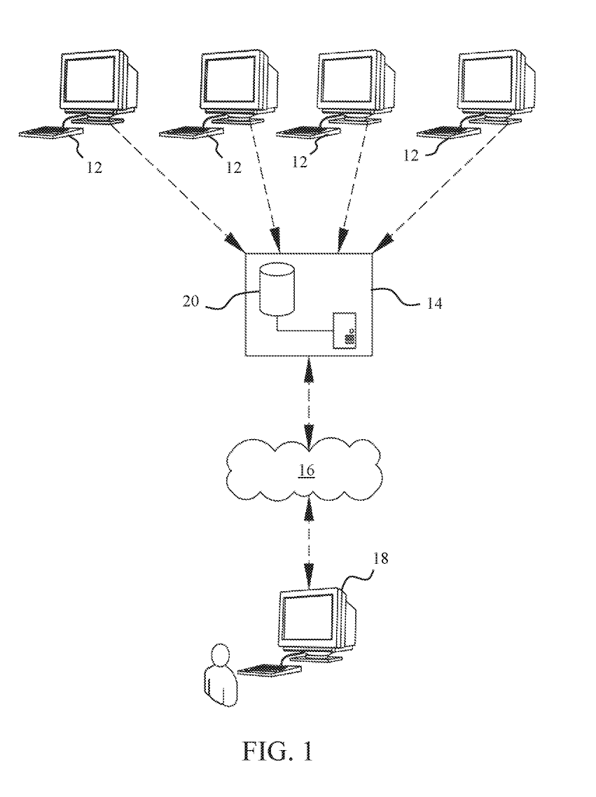

Referring to FIG. 1, there is shown an environment 10 to determine defects per unit (DPU) of a product using a product test data obtained from one or more of failure mode and effect analysis (FMEA), field issues analysis of the product, lab issues analysis of the product, and inherent issues analysis on previous machines. The product may include, but is not limited to, an engine system, a drive train, and an undercarriage assembly of a construction machine. In an embodiment, the environment 10 includes a multiplicity of data sources 12, a database server 14, a network 16, and a user-computing device 18.

The data sources 12 are computing devices that are communicably connected to the database server 14 of the environment 10, through a wired or wireless connection. The data sources 12 are adapted to receive product information of several products, as an input from a user. The product information may include, but is not limited to, an NPI (New Product Introduction) ID of a product, pre-production reliability data, process reliability data, and/or field failure data of the product. Receipt of multiple product information for a singular product may be contemplated. The data sources 12 are further adapted to generate a data updating session with the database server 14 and correspondingly transmit the product information to the database server 14. In an embodiment, the data sources 12 may connect to the database server 14 by utilizing one or more protocols such as, but are not limited to, Open Database Connectivity (ODBC) protocol and Java database connectivity (JDBC) protocol. Examples of the data sources 12 may include, but is not limited to, a personal laptop, a minicomputer, a personal digital assistant (PDA).

The database server 14 includes a storage unit 20 that stores the product information of a number of products received from the data sources 12. The database server 14 is a central storage device that receives product information from the data sources 12 through queries, during the data updating session. Some examples of the queries may include, but are not limited to, Structured query language (SQL), Visual Basics application (VBA), Contextual query language (CQL), and Hyper-text structured query language (HTSQL). In an embodiment, the database server 14 is realized through various technologies such as, but not limited to, Microsoft® SQL Server, Oracle®, IBM DB2®, Microsoft Access®, PostgreSQL®, MySQL® and SQLite®, and the like. Hereinafter the product information of the number of products is referred to as ‘centralized data’.

In an embodiment, the network 16 corresponds to a communication medium through which the database server 14 and the user-computing device 18 communicate with each other. Such a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The network 16 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

The user-computing device 18 is adapted to determine defects per unit of a product. More specifically, the user-computing device 18 is adapted to generate a data retrieval session with the database server 14, retrieve the product test data from the database server 14, determine the defects per unit of the product, and display the defects per unit of the product. The user-computing device 18 connects to the database server 14 through the network 16. The user-computing device 18 is a general computer system, such as but not limited to, a personal laptop, a minicomputer, and/or a personal digital assistant (PDA).

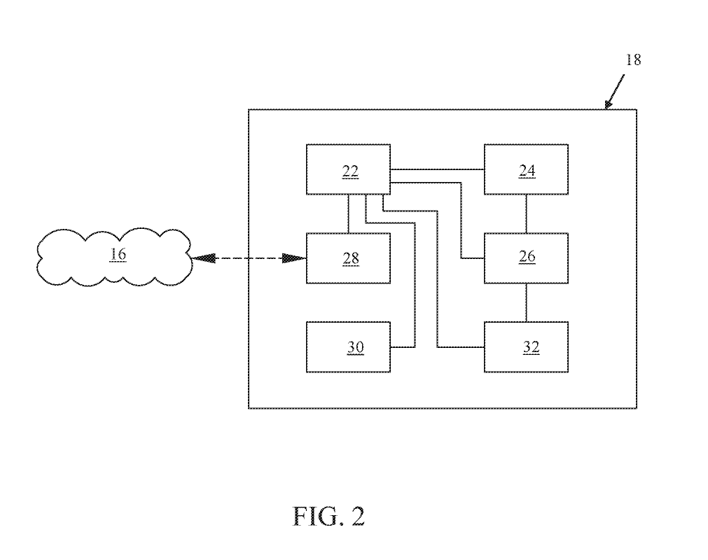

Referring to FIG. 2, there is shown a block diagram of the user-computing device 18. The user-computing device 18 includes a first processor 22, a first memory unit 24, an input unit 26, a first transceiver unit 28, a calculation unit 30, and a display unit 32. The first processor 22 is connected to the first memory unit 24, the input unit 26, the first transceiver unit 28, the calculation unit 30, and the display unit 32.

The first processor 22 comprises suitable logic, circuitry, interfaces, and/or code that are configured to execute a set of instructions stored in the first memory unit 24. The first processor 22 is implemented based on a number of processor technologies known in the art. The first processor 22 works in conjunction with the calculation unit 30 to determine defects per unit of a product. Examples of the first processor 22 include, but is not limited to, an X86-based processor, a Reduced Instruction Set Computing (RISC) processor, an Application-Specific Integrated Circuit (ASIC) processor, a Complex Instruction Set Computing (CISC) processor, and/or other processor.

The first memory unit 24 comprises suitable logic, circuitry, interfaces, and/or code that is configured to store the set of instructions, which are executed by the first processor 22 to perform predetermined operation on the user-computing device 18. In an embodiment, the first memory unit 24 is configured to store one or more programs, routines, or scripts that are executed by the first processor 22 in conjunction with the calculation unit 30. The first memory unit 24 is implemented based on a Random Access Memory (RAM), a Read-Only Memory (ROM), a Hard Disk Drive (HDD), a storage server, or a Secure Digital (SD) card.

The input unit 26 comprises various input devices that are adapted to communicate with the first processor 22. In an embodiment, the input unit 26 is further adapted to receive an input from the user. More specifically, the input unit 26 receives an NPI ID of the product (not shown), for which defects per unit is to be determined by the user-computing device 18. Examples of the input unit 26 may include, but are not limited to, a keyboard, a mouse, a joystick, a touch screen, a microphone, a camera, and/or a docking station.

The first transceiver unit 28 comprises of suitable logic, circuitry, interfaces, and/or code that is configured to generate a data retrieval session with the database server 14 through the network 16. In an embodiment, the first transceiver unit 28 may be further configured to transmit the NPI ID of the product, as a query, for which the defects per unit needs to be calculated. The first transceiver unit 28 may receive the product test data based on the transmitted NPI ID. The first transceiver unit 28 implements one or more known technologies to support wired or wireless communication with the network 16. In an embodiment, the first transceiver unit 28 includes, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The first transceiver unit 28 communicates via wireless communication with networks, such as the Internet, an Intranet and/or a wireless network, such as a cellular telephone network, a wireless local area network (LAN) and/or a metropolitan area network (MAN). The wireless communication uses any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The calculation unit 30 comprises of suitable logic, circuitry, interfaces, and/or code to calculate the defects per unit based on the product test data received by the first transceiver unit 28. More specifically, the calculation unit 30 determines the defects per unit by performing a calculation on a combination of the product test data, an NPI data, and, a CPI data. In an embodiment, the calculation unit 30 is adapted to receive the product test data from the first transceiver unit 28. In an embodiment, the calculation unit 30 is implemented or realized using an FPGA (field programmable gate array) or ASIC (application specific gate array).

The display unit 32 comprises of suitable logic, circuitry, interfaces, and/or code that is adapted to display the defects per unit of the product, as determined by the calculation unit 30. The display unit 32 is further adapted to display the defects per unit through a user interface. In an embodiment, the calculated data associated with defects per unit can be represented as a glide path, or any other graphical representation. Examples of the display unit 32 may include, but is not limited to, an LED display, a plasma display, or a cathode ray tube (CRT) display. Although, the present disclosure describes a separate input unit 26 and a separate display unit 32, it may be contemplated that the input unit 26 and the display unit 32 may be integrally mounted in a singular input/output unit. For example, a touch screen may be employed to facilitate a function of both of the input unit 26 and the display unit 32.

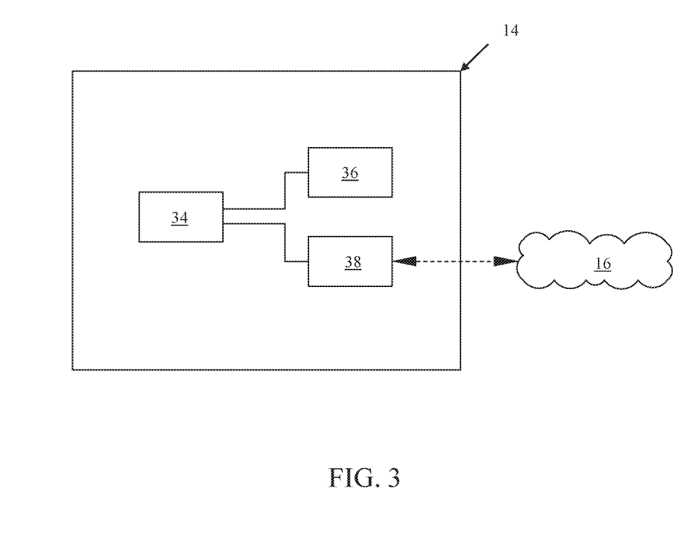

Referring to FIG. 3, there is shown a block diagram of the database server 14. The database server 14 includes a second processor 34, a second memory unit 36, and a second transceiver unit 38.

The second processor 34 comprises suitable logic, circuitry, interfaces, and/or code that is configured to execute a set of instructions stored in the second memory unit 36. The second processor 34 is implemented based on a number of processor technologies known in the art. The second processor 34 manages the connection between the data sources 12 and the user-computing device 18 through the second transceiver unit 38. Examples of the second processor 34 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The second memory unit 36 comprises suitable logic, circuitry, interfaces, and/or code that is configured to store the set of instructions, which are executed by the second processor 34 to perform predetermined operation on the database server 14. The second memory unit 36 is implemented based on a Random Access Memory (RAM), a Read-Only Memory (ROM), a Hard Disk Drive (HDD), a storage server, and/or a Secure Digital (SD) card.

The second transceiver unit 38 comprises of suitable logic, circuitry, interfaces, and/or code that is configured to generate a data retrieval session with the user-computing device 18 through the network 16. In an embodiment, the second transceiver unit 38 is further adapted to generate a data updating session with the data sources 12. The second transceiver unit 38 terminates the data updating session when the data retrieval session is generated by the second transceiver unit 38. During the data retrieval session, the second transceiver unit 38 is further adapted to receive the NPI ID of the product, as a query, from the user-computing device 18. The second transceiver unit 38 transmits the product test data to the user-computing device 18 based on the received NPI ID. The second transceiver unit 38 implements one or more known technologies to support wired or wireless communication with the network 16. In an embodiment, the second transceiver unit 38 includes, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The second transceiver unit 38 communicates via wireless communication with networks, such as the Internet, an Intranet and/or a wireless network, such as a cellular telephone network, a wireless local area network (LAN) and/or a metropolitan area network (MAN). The wireless communication uses any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

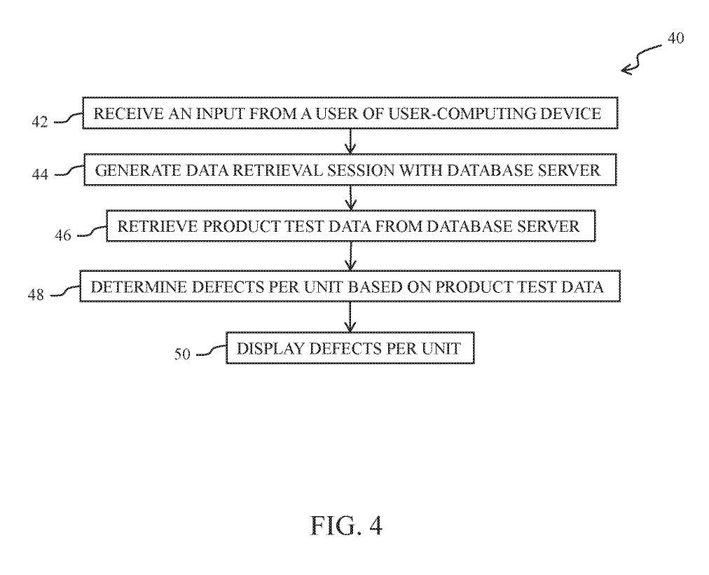

Referring to FIG. 4, there is shown a flowchart of a method 40 followed by the user-computing device 18, to determine the defects per unit of the product. Before initiating the method 40, the database server 14 generates the data updating session with the data sources 12. The data sources 12 update the centralized data stored in the storage unit 20 of the database server 14. The method 40 initiates at step 42.

At step 42, an input is received from the user of the user-computing device 18. In an embodiment, the first processor 22 receives the input from the user through the input unit 26. The input is received through the user-interface displayed on the display unit 32. In an embodiment, the input corresponds to NPI ID of the product for which the defects per unit needs to be calculated. The method 40 then proceeds to step 44.

At step 44, the data retrieval session is generated between the user-computing device 18 and the database server 14. In an embodiment, the first processor 22 instructs the first transceiver unit 28 to generate the data retrieval session with the database server 14. During the data retrieval session, the database server 14 suspends/terminates the data updating session with the data sources 12. Further, during the data retrieval session, the first processor 22 instructs the first transceiver unit 28 to transmit the NPI ID to the database server 14 as a query. The method 40 then proceeds to step 46.

At step 46, the product test data of the product is retrieved from the database server 14. In an embodiment, the first transceiver unit 28 receives the product test data, in response to the NPI ID sent at step 44. As the data updating session between the database server 14 and the data sources 12 has been terminated, the data sources 12 cannot update the database server 14. Further, as the retrieved product test data is stored locally on the user-computing device 18, the retrieved product test data is inaccessible to the data sources 12.

After the product test data is retrieved from the database server 14, the data retrieval session between the database server 14 and the user-computing device 18 is terminated. Additionally, the database server 14 re-generates the data updating session with the data sources 12. In an embodiment, the data updating session is re-generated after the user-computing device 18 receives the product test data. In an embodiment, the first transceiver unit 28 sends information pertaining to successful reception of the product test data to the database server 14. The method 40 then proceeds to step 48.

At step 48, the defects per unit of the product is determined. In an embodiment, the calculation unit 30 of the user-computing device 18 calculates the defects per unit based on the product test data. The method 40 then proceeds to end step 50.

At end step 50, the display unit 32 of the user-computing device 18 displays the defects per unit of the product. More specifically, the display unit 32 displays the defects per unit of the product in a graph. The graph depicts defects per unit of the product on the ordinate and date of determination on the abscissa.

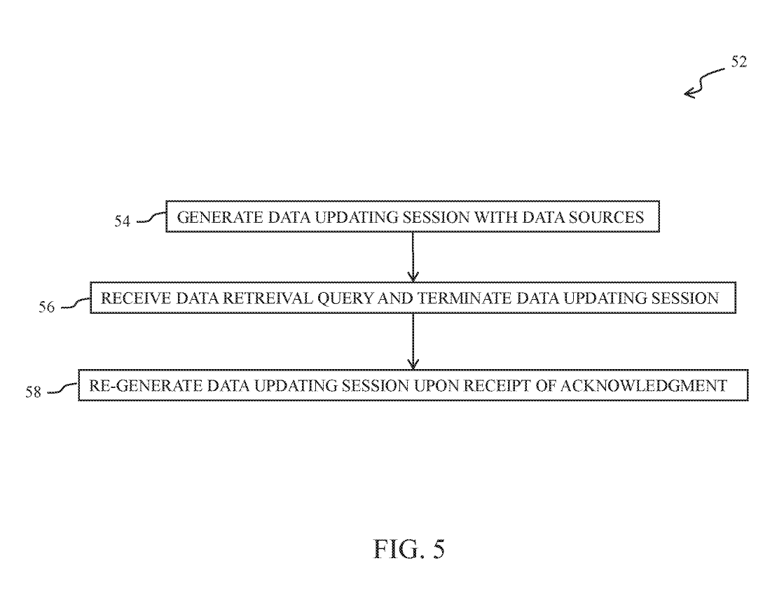

Referring to FIG. 5, there is shown a flowchart of a method 52 followed by the database server 14, to determine the defects per unit of the product. Notably, the method 52 followed by the database server 14, works in conjunction with, the method 40 followed by the user-computing device 18, to determine defects per unit of the product. The method 52 initiates at step 54.

At step 54, the second transceiver unit 38 generates data updating session with the data sources 12. During the data updating session, the data sources 12 updates the product information of various products. The method 52 then proceeds to step 56.

At step 56, the second transceiver unit 38 receives a query from the user-computing device 18. In an embodiment, the query comprises of the NPI ID of the product for which the defects per unit needs to be calculated. In an embodiment, on receiving the query, the second processor 34 instructs the second transceiver unit 38 to generate a data retrieval session with the user-computing device 18. Concurrently, the second processor 34 instructs the second transceiver unit 38 to terminate the data updating session with the data sources 12.

The second processor 34, during the data retrieval session, transmits the product test data pertaining to the received NPI ID. In an embodiment, the second processor 34 transmits the product test data through the second transceiver unit 38. The method 52 then proceeds to step 58.

At step 58, the second transceiver unit 38 re-establishes the data updating session with the data sources 12 after the product test data has been transmitted to the user-computing device 18.

### INDUSTRIAL APPLICABILITY

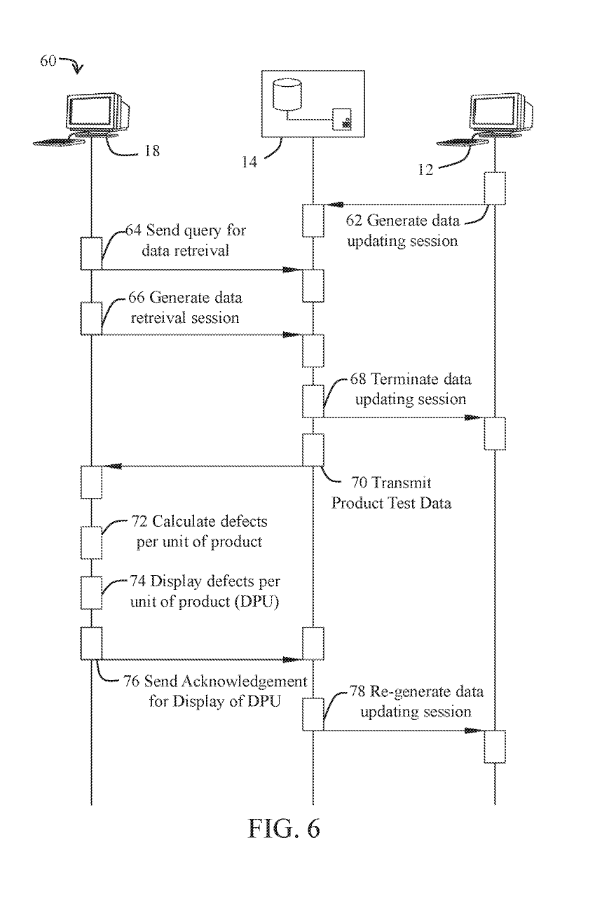

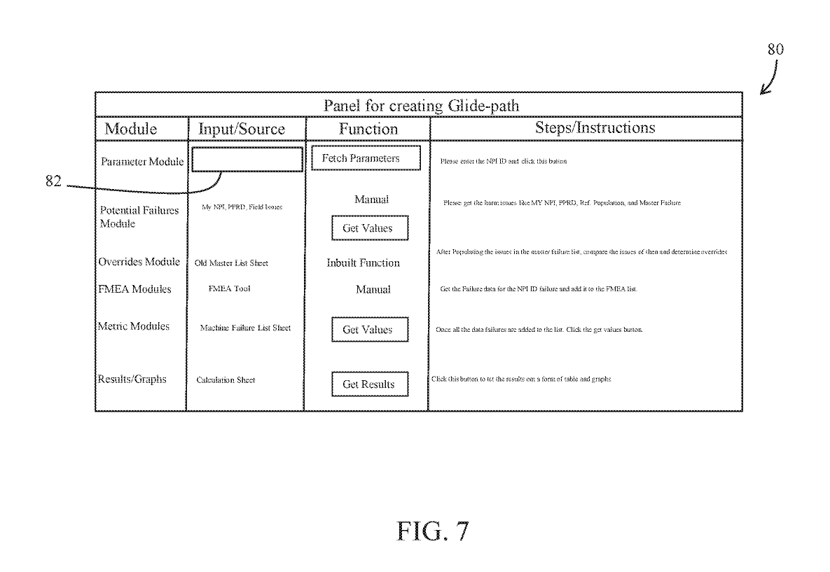

Referring to FIGS. 6 and 7, a method of determining the defects per unit of a product is described. The method of determining the defects per unit of the product is described by discussing the method 40 performed by the user-computing device 18 combined with the method 52 performed by the database server 14. The method includes generating data updating session between the data sources 12 and the database server 14, generating data retrieval session between the database server 14, and the user-computing device 18, retrieving product test data from the database server 14, determining defects per unit based on retrieved the product test data, displaying the determined defects per unit. Hereinafter, the method of determining the defects per unit of the product will be explained based on the message flow diagram 60 (FIG. 6).

In operation, the data sources 12 initially sends an update session message (depicted at a first message block 62 of the message flow diagram 60) to the second processor 34 of the database server 14. This facilitates generation of the data updating session between the data sources 12 and the database server 14. The second processor 34 actuates the second transceiver unit 38, to receive product information of several products from the data sources 12 and updates the centralized data.

When required to determine the defects per unit of a product, a user initially inputs an NPI ID of the product to an NPI ID input column 82 (FIG. 7) of an input window 80 (FIG. 7). The input unit 26 of the user-computing device 18 then receives this NPI ID given by the user. Upon receiving the NPI ID by the input unit 26, the first processor 22 of the user-computing device 18 sends a query message (depicted at a second message block 64 of the message flow diagram 60) to the second processor 34 of the database server 14. The query message corresponds to a query to retrieve the product test data from the database server 14. Thereafter, the first processor 22 actuates the first transceiver unit 28 of the user-computing device 18. The first transceiver unit 28 of the user-computing device 18 then sends a retrieval session message (depicted at a third message block 66 of the message flow diagram 60) to the database server 14. The retrieval session message corresponds to creation of the data retrieval session between the database server 14 and the user-computing device 18. Upon receiving the session creation message, the second transceiver unit 38 of the database server 14 sends a termination signal (depicted at a fourth message block 68 of the message flow diagram 60) to the data sources 12. The termination message corresponds to termination of the data updating session between the database server 14 and the data sources 12.

After termination of the data updating session, the database server 14 sends a retrieval message (depicted at a fifth message block 70 of the message flow diagram 60) to the user-computing device 18. The retrieval message corresponds to transmitting the product test data of the product from the database server 14 to the user-computing device 18. Upon receiving the product test data from the database server 14, the calculation unit 30 of the user-computing device 18 calculates and determines defects per unit of the product, as is depicted by a sixth message block 72 of the message flow diagram 60. Thereafter, the display unit 32 of the user-computing device 18 graphically displays the defects per unit of the product, as is depicted by a seventh message block 74 of the message flow diagram 60. After display, the first transceiver unit 28 of the user-computing device 18 delivers an acknowledgement message (depicted at an eight message block 76 of the message flow diagram 60) to the second processor 34 of the database server 14. The acknowledgement message corresponds to completion of the display of the defects per unit of the product. Thereafter, the second transceiver unit 38 of the database server 14 sends the update session message (depicted at a ninth message block 78 of the message flow diagram 60) to the data sources 12. The update message corresponds to re-generation of the data updating session between the data sources 12 and the database server 14. It may be noted that the operator performs the method 40 at regular intervals of time to form a graphical representation (termed as ‘glide-path’) of the defects per unit of the product relative to time. As the data updating session is terminated during the data retrieval session, a centralized data in the database server 14 is not updated during retrieval of the product test data. Therefore, an accurate retrieval of the product test data is facilitated. This corresponds to a relatively more precise and accurate determination of the defects per unit of the product.

It should be understood that the above description is intended for illustrative purposes only and is not intended to limit the scope of the present disclosure in any way. Thus, one of ordinary skill in the art will appreciate that other aspects of the disclosure may be obtained from a study of the drawings, the disclosure, and the appended claim.

What is claimed is:

1. A method implemented on a computing device for determining defects per unit of a product, the computing device including a processor and a display unit, the method comprising:
generating a data retrieval session between the processor and a database server;
retrieving a product test data from the database server based on a query executed by the processor,
generating a data updating session between the database server and a plurality of data sources,
wherein the data updating session between the database server and the plurality of data sources being terminated during retrieval of the product test data,
wherein the product test data retrieved being inaccessible by the plurality of data sources;
determining a measure of defects per unit based on the product test data retrieved from the database server; and
displaying the defects per unit through the display unit, wherein the database server being structured and arranged to reactivate the data updating session with the plurality of data sources in response to the conclusion of the display of the defects per unit.
